(19) United States
(12) Patent Application Publication
(10) Pub. No.: US 2020/0278867 A1
(43) Pub. Date: Sep. 3, 2020

(54) DEVICE, PROCESSOR, AND METHOD FOR SPLITTING INSTRUCTIONS AND REGISTER RENAMING

(71) Applicant: ALIBABA GROUP HOLDING LIMITED, George Town (KY)

(72) Inventors: Chang LIU, Shanghai (CN); Feng ZHU, Hangzhou (CN)

(21) Appl. No.: 16/802,341

(22) Filed: Feb. 26, 2020

(30) Foreign Application Priority Data
Mar. 1, 2019 (CN) 201910156496.4

(51) Int. Cl. G06F 9/38; G06F 9/30

(52) U.S. Cl. CPC G06F 9/3818; G06F 9/30098; G06F 9/30021; G06F 9/384

(57) ABSTRACT

Embodiments of the present disclosure provides a processor, a device, and a method for executing instructions, comprising: decoding instructions to identify a instruction to be split; splitting the identified instruction into two or more split instructions, the split instructions including correlated instructions having a correlation, and the correlated instructions having a corresponding virtual register; performing register renaming on the split instructions, wherein for the correlated instructions, a first physical register configured to save results and allocated to the corresponding virtual register is the same as a second physical register designated to be released after executing at least one of the split instructions; and executing the split instructions after the register renaming.

### CROSS REFERENCE TO RELATED APPLICATION

This disclosure claims the benefits of priority to Chinese application number 201910156496.4, filed Mar. 1, 2019, which is incorporated herein by reference in its entirety.

### BACKGROUND

Generally, an instruction set supported by a processor has been defined in advance, and the processor can execute various instructions defined by the instruction set. As the processor performance becomes more powerful and processor applications extend to more fields, instructions included in an instruction set also become more complicated. Some complicated instructions may be split into a plurality of split instructions prior to execution by the processor. Some split instructions are correlated. For example, the execution of some subsequent split instructions may depend on execution results of one or more split instructions previously executed. But splitting these complicated instruction sets can be inefficient and can consume substantial hardware resource.

### SUMMARY OF THE DISCLOSURE

The present disclosure provides a processor, a device, and a method for executing instructions including splitting instructions and register renaming to solve or alleviate at least one of the above problems.

The present disclosure provides a method for executing instructions, comprising: decoding instructions to identify an instruction to be split; splitting the identified instruction into two or more split instructions, the split instructions comprising correlated instructions having a correlation, and the correlated instructions having a corresponding virtual register; performing register renaming on the split instructions, wherein for the correlated instructions, a first physical register configured to store results and allocated to the corresponding virtual register is the same as a second physical register designated to be released after executing at least one of the split instructions; and executing the split instructions after the register renaming.

In some embodiments, the method according to the present disclosure further comprises: making correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction.

In some embodiments, performing register renaming comprises: allocating the first physical register to the destination register in the split instructions and designating the second physical register to be released after executing the producer instruction; and designating a third physical register from which a value is taken for the source register in the consumer instruction, wherein for the corresponding virtual register in the producer instruction, the allocated first physical register is the same as the designated second physical register to be released after executing the producer instruction, and wherein the designated third physical register for the corresponding virtual register in the consumer instruction is the same as the first physical register configured to store results and allocated to the corresponding virtual register in the producer instruction.

In some embodiments, performing register renaming further comprises: recording, in a register renaming table, information of the first physical register allocated to the destination register in the split instructions and information of the designated second physical register to be released after executing the producer instruction.

In some embodiments, the information of the corresponding first physical register, the information of the second physical register released after executing the producer instruction, and a ready mark of the corresponding virtual register are recorded in the register renaming table for the virtual register, wherein the ready mark indicates whether the value in the virtual register is ready, In some embodiments, executing the renamed split instructions comprises: saving the consumer instruction in an issue queue; and fetching the consumer instruction from the issue queue and executing the consumer instruction when the ready mark of the virtual register associated with the consumer instruction in the register renaming table indicates a Ready state.

In some embodiments, the correlation mark further comprises a mapping relation between the corresponding virtual register and the first physical register, and performing register renaming comprises: recording, for the producer instruction, the allocated first physical register in the correlation mark; and acquiring, for the consumer instruction, the allocated first physical register according to the correlation mark as the third physical register designated for the corresponding virtual register and from which a value is taken.

In some embodiments, the register renaming of the producer instruction and the register renaming of the consumer instruction are not performed in the same processor cycle, and performing register renaming comprises: writing, for the producer instruction, a number of the corresponding virtual register and a number of allocated first physical register into a particular register; and reading, for the consumer instruction, the number of the allocated first physical register from the particular register to serve as the number of the third physical register designated for the corresponding virtual register and from which a value is taken.

In some embodiments, the correlation mark is implemented using a signal and/or a table entry record.

According to another aspect of the present disclosure, an instruction executing device is provided, comprising: a decoding unit configured to decode instructions to identify an instruction to be split; an instruction splitting unit configured to split the identified instruction into two or more split instructions, the split instructions comprising correlated instructions having a correlation, and the correlated instructions having a corresponding virtual register; a register renaming unit configured to perform register renaming on the split instructions, wherein for the correlated instructions, a first physical register configured to store results and allocated to the corresponding virtual register is the same as a second physical register designated to be released after executing at least one of the split instructions; and an executing unit configured to execute the split instructions after the register renaming.

According to still another aspect of the present disclosure, a processor comprising an instruction executing device according to the present disclosure is provided, the instruction executing device comprising: a decoding unit configured to decode instructions to identify an instruction to be split; an instruction splitting unit configured to split the identified instruction into two or more split instructions, the split instructions comprising correlated instructions having a correlation, and the correlated instructions having a corresponding virtual register; a register renaming unit configured to perform register renaming on the split instructions, wherein for the correlated instructions, a first physical register configured to store results and allocated to the corresponding virtual register is the same as a second physical register designated to be released after executing at least one of the split instructions; and an executing unit configured to execute the split instructions after the register renaming.

According to the solution of the present disclosure, after instructions are split, the problem of contamination of the virtual register can be avoided. In some embodiments, register contamination happens when a virtual register used in one or more instructions, is further used to convey information between two correlated split instructions (e.g., a producer instruction and a consumer instruction). For example, the virtual register is allocated with another physical register to temporarily store intermediate result from the first producer instruction, which is used as a source in the second consumer instruction. Sometimes the association between the temporarily allocated physical register and the virtual register may not be timely updated after executing the instruction, causing errors and confusions in executing other instructions and resulting in undesired register contamination. In addition, when the physical register allocated to the virtual register for storing the intermediate result is occupied with outdated data (e.g., the intermediate result) that is no longer needed, without timely releasing and freeing the outdated content from the physical register, new and useful data cannot be effectively stored in the physical register in accordance with updating the virtual register and/or future new register allocation. As discussed in some embodiments of the present disclosure, during register renaming, a physical register configured to save the execution result is allocated for a correlated virtual register. Meanwhile, the same physical register is designated to be released after executing the instruction (e.g., a split instruction, such as a producer instruction). In addition, when register renaming is performed (e.g., for a correlated split instruction, such as a consumer instruction correlated to the producer instruction), the same physical register is further allocated to the correlated virtual register of the consumer instruction by referring to a correlation mark (e.g., assigned to the producer instruction and the consumer instruction), instead of referring to the register renaming table. The solution discussed in various embodiments in the present disclosure solves the conventional problems of transferring intermediate results between the correlated instructions, so that instruction splitting can be implemented with a reduced physical resource overhead and without contaminating the virtual register.

### BRIEF DESCRIPTION OF THE DRAWINGS

In order to achieve the above and related objectives, some illustrative embodiments are described herein with reference to the following description and accompanying drawings. These aspects indicate a variety of embodiments in which the principles disclosed herein can be practiced, and all the aspects and their equivalent aspects are intended to fall within the scope of the subject matter claimed for protection. The above and other objectives, features and advantages of this disclosure will be clearer by reading the following detailed description with reference to the accompanying drawings. The same reference numerals generally represent the same components or elements throughout this disclosure.

FIG. 1 is a schematic diagram of an exemplary method for executing instructions, according to some embodiments of the present disclosure.

FIG. 2 is a schematic diagram of an exemplary processor for executing instructions, according to some embodiments of the present disclosure.

### DETAILED DESCRIPTION

Exemplary embodiments of this disclosure are described in more detail below with reference to the accompanying drawings. Although the exemplary embodiments of this disclosure are shown in the accompanying drawings, it should be understood that this disclosure may be implemented in various forms and should not be limited by the embodiments illustrated here. On the contrary, these embodiments are provided so that this disclosure can be understood more thoroughly and the scope of this disclosure can be fully conveyed to those skilled in the art.

In existing instruction splitting solutions, one conventional method includes establishing a correlation between the split instructions, e.g., by using the same virtual register as used in one of the instructions. However, the virtual register may be contaminated due to a register renaming mechanism during instruction execution, and negatively affect the performance of subsequent register renaming and instruction execution. Another conventional method includes adding to the processor a virtual register specifically configured to save intermediate results of the split instructions. This method may avoid the contamination of the virtual register but may increase in excessive hardware resource consumption. Yet another conventional method includes constructing a data path between executing units to transmit intermediate results. Various split instructions may enter into different executing units respectively, and intermediate results may be transmitted by the data path constructed between the different executing units. But if the correlation between the split instructions is very complicated, the control logic will be very complicated, and the data path between the different executing units will also need to consume additional hardware resources.

The present disclosure overcomes these issues by providing a processor, a device, and a method for executing instructions more efficiently, utilizing less hardware resources than the conventional systems described above.

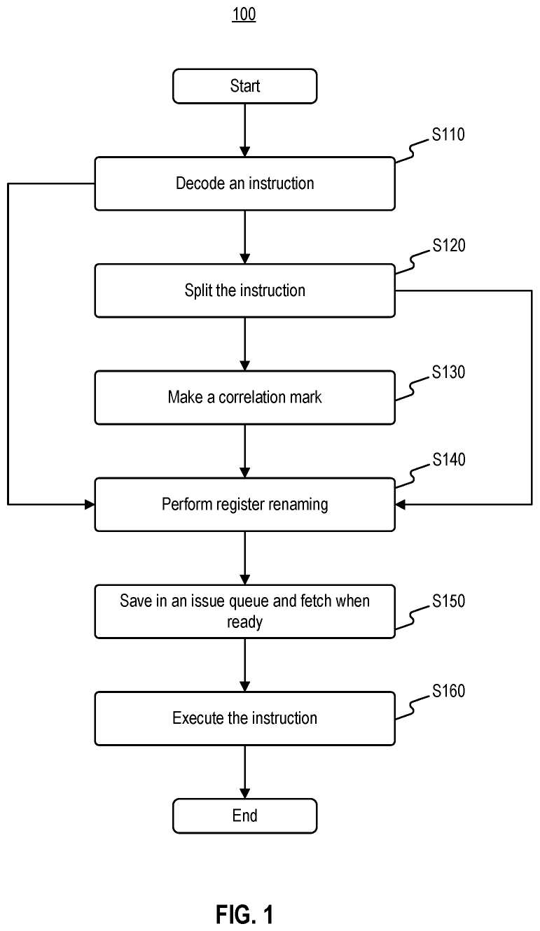

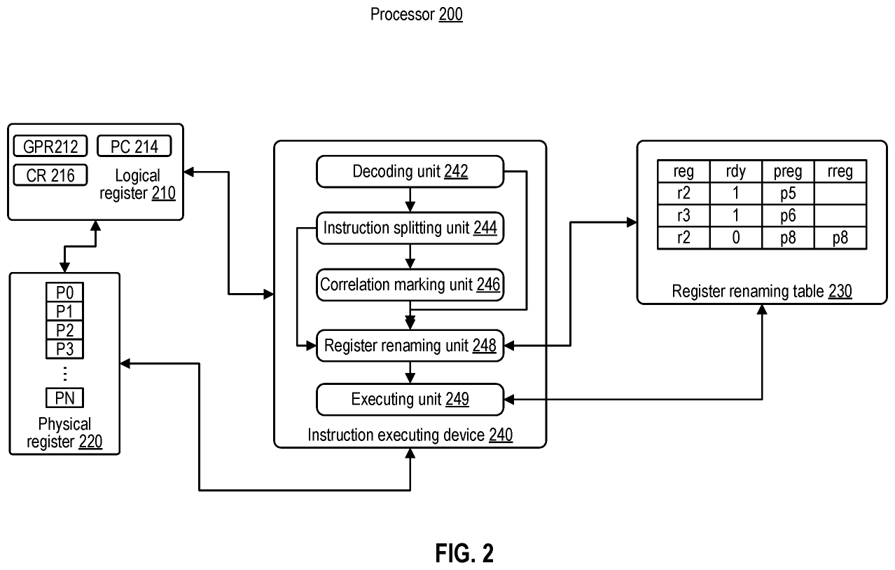

FIG. 1 is a schematic diagram of an exemplary method 100 for executing instructions, according to some embodiments of the present disclosure. Method 100 may be executed in a processor, for example, processor 200 as shown in FIG. 2. In some embodiments, processor 200 includes a plurality of registers and supports one or more predefined instruction sets. An instruction set defines a set of instruction types that can be executed by processor 200.

In some embodiments, an instruction includes an operation code (e.g., an opcode) and an operand. The operation code indicates what operation(s) will be performed in accordance with the instruction. A source operand in the operand may indicate a data source (e.g., the data to be delivered or the address of a register or a memory space for storing the data) for executing the instruction, and a destination operand indicates an address of a register or a memory space associated with storing an execution result of the instruction. The source operand and the destination operand often involve the use of registers. For example, the source operand may indicate a value stored in a register, or may indicate a value stored at a location of a storage space indicated by a value stored in the register. The register associated with the source operand can be referred to as a source register. The destination operand may indicate an execution result to be stored in a register or may indicate the execution result to be stored in a storage location indicated by a value in the register. The register associated with the destination operand can be referred to as a destination register.

In some embodiments, an instruction set defines various types of instructions, including the purpose of each register in the instructions. In some embodiments, the definitions of the instructions included in the instruction set are logical definitions. In some embodiments, to support the instruction set, one or more virtual registers 210 (e.g., also referred to as logical registers or architectural registers) are defined in processor 200, such as a general-purpose register (GPR) 212, a program counter (PC) 214, and a control register (CR) 216. In some embodiments, the definitions of virtual registers 210 are logical (e.g., as opposed to physical), and access permissions can be set for accessing virtual registers 210. In some embodiments, virtual registers 210 can also be referred to as virtual registers, or architectural registers. When executing instructions, one or more actual physical registers 220 may be allocated to a virtual register 210 via register renaming. In some embodiments as shown in FIG. 2, processor 200 includes a plurality of physical registers 220 (e.g., P0, P1, . . . PN). It is appreciated that the number of physical registers 220 included in processor 200 may depend on the design of processor 200, and that the present disclosure is not limited to a specific number of physical registers 220 included in processor 200.

As shown in FIG. 1, method 100 starts from step S110. In step S110, an instruction is decoded. In some embodiments in step S110, the instruction is analyzed to determine an operation code of the instruction, and specific operation(s) to be performed in accordance with the instruction. Moreover, in step S110, according to the decoding result, it is determined whether the instruction will be split. Because a specific function of the instruction is known after the instruction is decoded, whether the instruction will to be split can be determined in step S110. As further discussed below, instruction splitting (e.g., discussed with reference to step S120) can be performed to instructions that are determined to be split, and register renaming (e.g., discussed with reference to step S140) can be performed to instructions that are determined not to be split (e.g., non-split instructions).

Method 100 proceeds to step S120 to split an instruction that is determined in step S110 to be split. In some embodiments, a method of splitting the instruction has been defined in processor 200, including how many split instructions the instruction may be split into, and whether the split instructions correlate to each other. In some embodiments, after splitting the instructions, in step S120, the split instructions that may correlate to each other (e.g., correlated split instructions) or may not correlate to each other (e.g., uncorrelated split instructions) are further identified.

In some embodiments, an instruction that combines a write instruction with an addressing mode based on a register shifting may be expressed as str.w r1, (r2, r3). In some embodiments, the instruction str.w r1, (r2, r3) indicates that a storage location (e.g., a memory space) to which data from register r1 is written may be indicated by a value obtained by adding data in registers r2 and r3 (e.g., as shifting or offsetting the value in register r2 by the value in register r3). In some embodiments, if processor 200 cannot support a direct execution of an instruction such as str.w r1, (r2, r3), the instruction may be split. In some embodiments, the instruction may be split into two split instructions by processor 200. For example, the first split instruction is an add instruction including addu r2, r2, r3, e.g., indicating that the sum of data in r2 and r3 is calculated and the calculation result is saved in register r2. The second split instruction includes st.w r1, r2, e.g., indicating that the data in register r1 is written into a storage location indicated by the value in register r2.

In the process of executing the instruction, if the operand required by the latter instruction is the execution result of the former instruction, the two instructions are correlated. In some embodiments, the latter instruction may be executed after the execution of the former instruction is completed. In some embodiments, the former instruction is referred to as a producer instruction, and the latter instruction is referred to as a consumer instruction. The consumer instruction depends on the producer instruction. As in the example given above, for two split instructions obtained after splitting the instruction str.w r1, (r2, r3), the second split instruction may use an execution result of the first split instruction. Accordingly, the two split instructions are correlated. For example, the first split instruction is a producer instruction, and the second split instruction is a consumer instruction. In some embodiments the producer instruction and the consumer instruction use a corresponding correlated virtual register. For example, the correlated virtual register is used as a destination register in the first split instruction, and used as a source register in the second split instruction. In some embodiments as discussed with reference to the instruction str.w r1, (r2, r3) as discussed above, the two split instructions use a corresponding correlated virtual register r2. In some embodiments, virtual register r2 is used as a destination register in the first split instruction addu r2, r2, r3 to store the result of the add instruction, and is used as a source register in the second split instruction st.w r1, r2 to read an address of a storage location from r2.

In some embodiments, in response to splitting the instruction in step S120, correlated instructions in the split instructions may be identified. Further, among the correlated instructions, the producer instructions and the correlated consumer instructions may also be identified.

In some embodiments, in step S130, the correlated instructions in the split instructions are marked with correlation marks. In some embodiments, a correlation mark may be used to indicate that a producer instruction and a consumer instruction are correlated to each other in the split instructions.

In some embodiments, in step S140, register renaming is performed on different types of instructions, including non-split instructions (e.g., instructions that are determined not to be split in step S110), uncorrelated split instructions (e.g., identified in step S120), and correlated split instructions (e.g., identified in step S120). In step S140, processor 200 allocates an idle physical register to a virtual register (e.g., a destination register) indicated in the instruction for saving a calculation result obtained from executing the instruction. For example, the allocated physical register is used for storing data from the calculation result. In some embodiments, processor 200 further determines a physical register to be released after executing the instruction (e.g., after executing the producer instruction and prior to executing the consumer instruction). In some embodiments, the virtual register may be used repeatedly during instruction execution. In some embodiments, the previous data stored in a physical register indicated by the previous value in the logical register becomes meaningless and is no longer needed after the value of the virtual register is updated. As a result, in addition to allocating a physical register (e.g., a physical register configured to save calculation results) to the destination register, processor 200 may also determine (e.g., designate) a physical register to be released and recovered after executing the instruction. In some embodiments, by timely releasing and recovering the physical registers that store outdated data, processor 200 can optimize processor performance by avoiding or reducing register contamination (e.g., a virtual register is used for storing a value related to a temporarily allocated physical register for storing intermediate result, and the physical register is occupied with outdated data that is no longer needed, as a result, without updating the virtual register value or the allocation with the physical register, and without releasing and freeing the outdated content from the physical register, the virtual register may be contaminated, and new and useful data cannot be effectively stored in the physical register in accordance with updating the virtual register or future new register allocation).

In some embodiments, for the producer instruction in the correlated split instructions determined in step S130, the correlated virtual register is a destination register. In some embodiments, during the register renaming in step S140, a physical register configured to store results obtained from executing the producer instruction is allocated to the destination register, and a physical register to be released after executing the producer instruction is also designated. In some embodiments, the physical register allocated to the destination register and configured to store results from executing the producer instruction is set to be the same physical register as the physical register designated to be released after executing the producer instruction. Accordingly, after executing the producer instruction, the physical register allocated to the correlated virtual register (e.g., the destination register) and configured to save intermediate results from executing the producer instruction is released. As a result, using correlated virtual register temporarily for instruction splitting may not cause register contamination and the processor performance could be optimized.

In some embodiments, performing the register renaming (e.g., as discussed with reference to step S140) further includes designating a corresponding physical register for a virtual register (e.g., a source register) used as a source operand in an instruction, so that content can be acquired from the designated physical register as the value used in the virtual register in the instruction.

In some embodiments, in response to performing the register renaming in step S140, for an instruction that is not marked as a consumer instruction in step S130, the instruction may be an instruction that will not be split, an uncorrelated split instruction, or a producer instruction in correlated split instructions. In some embodiments, the designated physical register is obtained according to a predetermined register renaming rule. In some embodiments, for the consumer instruction determined in step S130, the correlated virtual register associated with the consumer instruction is a source register. In some embodiments, a physical register can be designated for the correlated virtual register (e.g., the source register) according to the correlation mark (e.g., assigned to the producer instruction and the correlated consumer instruction in step S130). In some embodiments, the physical register designated for the source register is the same as the physical register configured to save calculation results from executing the producer instruction and allocated to the correlated virtual register (e.g., the correlated destination register).

In some embodiments as discussed above, in step S140, for the correlated instructions in the split instructions, the physical register allocated for the destination register and configured to store results from executing the producer instruction is the same as the physical register designated to be released after executing the producer instruction.

In some embodiments, register renaming results may be recorded in a register renaming table 230 as shown in FIG. 2. As shown in FIG. 2, one or more physical registers allocated to each virtual register (e.g., “reg”) are recorded in register renaming table 230. In some embodiments, the one or more physical registers allocated to a virtual register includes a physical register (e.g., “preg”) configured to store results (e.g., obtained from executing corresponding instructions) and a physical register (e.g., “rreg”) to be released upon completion of the instruction execution. Accordingly, for non-consumer instructions, physical registers designated for various virtual registers can be obtained by referring to register renaming table 230. In some embodiments, for a consumer instruction, a physical register configured to store results and designated for the correlated virtual register (e.g., the destination register in the first split instruction as well as the source register in the second split instruction) is identified from the renaming result of the producer instruction correlated to the consumer instruction based on the correlation mark (e.g., assigned in step S130). In some embodiments, register renaming table 230 may not be referred to when identifying the physical register for the consumer instruction.

In some embodiments, for a non-split add instruction such as addu r2, r2, r3 (e.g., indicating that the sum of data in r2 and r3 is calculated and the calculation result is saved in a physical register allocated to register r2 to replace the previous value associated with register r2), before the instruction is renamed, physical register p5 configured to store results may have been allocated to virtual register r2, and physical register p6 configured to store results may have been allocated to virtual register r3. In accordance with performing register renaming on the add instruction, a new idle physical register will be allocated to r2 which is used as a destination register. For example, p8 is used as a physical register configured to store results from executing the above non-split add instruction. In some embodiments, the value in virtual register r2 will be changed after completing the instruction execution. Accordingly, the physical register to be released after executing the instruction may be defined as p5. For example, after completing the instruction execution, physical register p5 is released and recovered for use in association with another virtual register, and the value of virtual register r2 can be obtained from physical register p8.

In some embodiments as shown in FIG. 2, the add instruction addu r2, r2, r3 may be a split instruction and a producer instruction (e.g., from splitting the instruction str.w r1, (r2, r3) as discussed above). In this case, the sum of data in r2 and r3 is calculated and the calculation result is saved in a physical register allocated to register r2. In some embodiments, different from replacing the previous value associated with r2 with the calculation result as discussed in the above non-split add instruction, in the split add instruction, the calculation result is used as an intermediate value, e.g., a destination operand in the first split instruction and a source operand in the second split instruction. As such, the physical register assigned to save the calculation result as an intermediate value may be timely released to efficiently free the physical register for future register allocation and to effectively optimize the processor performance. In addition, the physical register allocated to the virtual register remains to be the originally assigned physical register.

In some embodiments, when the add instruction addu r2, r2, r3 is a split add instruction as a producer instruction, before performing the register renaming process, physical register p5 configured to store results is allocated to virtual register r2 and physical register p6 configured to store results is allocated to virtual register r3. In some embodiments, in response to performing the register renaming on the split add instruction addu r2, r2, r3, virtual register r2 is a correlated virtual register (e.g., used as a destination register in the first split add instruction, and a source register in the second split instruction). In some embodiments, the physical register configured to store results (e.g., the intermediate result from executing the first split add instruction) and allocated to register r2 (e.g., temporarily) is physical register p8, which is the same as the physical register to be released after executing the instruction. Accordingly, after completing the instruction execution the value in logical register r2 may still be obtained from the previous physical register p5 by referring to register renaming table 230. In some embodiments, physical register p8 allocated to the correlated virtual register r2 for saving intermediate results is released after completing the execution of the split instruction. As a result, the problem of register contamination as discussed herein may be avoided.

In some embodiments, in addition to making correlation marks on the split instructions (e.g., establishing an association between the producer instruction and the consumer instruction as discussed with reference to step S130), the correlation mark may further be used to transfer information of the renamed physical registers between the correlated split instructions.

In some embodiments, information regarding a mapping relation between the correlated virtual register and the allocated physical register configured to store results can be included in the correlation mark. In some embodiments, in accordance with the register renaming performed in step S140, information related to the allocated physical register configured to store results may be recorded in the correlation mark after performing the register renaming on the producer instruction. In some embodiments, for the consumer instruction, the physical register configured to store results and allocated to the correlated virtual register may be identified by referring to the correlation mark. As such, the identified physical register configured to store results can be designated as a renamed physical register for the correlated virtual register used in the consumer instruction.

In some embodiments, when the register renaming for the producer instruction and the consumer instruction that are split from the same instruction are not performed in the same processor cycle, after performing register renaming on the producer instruction, the information of the correlated virtual register (e.g., a logical register number, such as r2) of the producer instruction, the information of the allocated physical register (e.g., a physical register number, such as p8) configured to store results, and the correlation relationship therebetween can be written into a particular register. In some embodiments, in another processor cycle, when register renaming is performed on the consumer instruction (e.g., in step S140), the information of the physical register (e.g., p8) configured to store results can be read, according to the correlation mark stored in the particular register, to serve as the physical register designated for the correlated virtual register of the consumer instruction.

In some embodiments, the correlation mark can be implemented in a variety of embodiments. In some embodiments, when register renaming of a producer instruction and a consumer instruction split from the same instruction are performed in the same processor cycle, the correlation mark can be implemented using signals to transmit the correlation mark between the producer instruction and the consumer instruction. In some other embodiments, when register renaming of the producer instruction and the consumer instruction are not performed in the same processor cycle, the correlation mark can be implemented using a table entry. For example, the correlation mark is recorded as an entry in a certain table. Accordingly, the producer instruction can record a mapping relation between the virtual register and the physical register configured to store results according to the recorded table entry. Moreover, the consumer instruction can acquire the mapping relation according to the table entry and obtain content used in the virtual register. The present disclosure is not limited to a specific implementation embodiment of the correlation mark. All suitable embodiments for establishing an association between the producer instruction and the consumer instruction and for transmitting the mapping relation between the virtual register and the physical register configured to store results are included in the protective scope of the present disclosure.

In some embodiments, after register renaming is performed in step S140, the instruction (e.g., a non-split instruction, an uncorrelated split instruction, or a correlated split instruction as discussed herein) may not be executed directly. In some embodiments, the instruction is executed after one or more register values required by the instruction indicate that the values in the one or more registers are ready to be obtained. In some embodiments, the instruction is executed only after all the register values required by the instruction are ready. In some embodiments, as shown in FIG. 2, a ready mark rdy is recorded in register renaming table 230 for each virtual register. The ready mark rdy indicates whether the value in the corresponding virtual register is ready to be obtained and used in the corresponding instruction. For example, as shown in register renaming table 230 in FIG. 2, integer 1 for the ready mark rdy may indicate that the value in corresponding logical register is ready, whereas integer 0 for the ready mark rdy may indicate that the corresponding logical register is not ready. Alternatively, integer 1 may be designated to indicate that a corresponding register is not ready, whereas integer 0 may be designated to indicate that the corresponding register is ready.

In some embodiments, after the register renaming is performed in step S140, method 100 proceeds to step S150 as shown in FIG. 1. In some embodiments in step S150, one or more instructions to be executed are stored in an issue queue. In some embodiments, further in step S150, an instruction indicating that all the virtual registers required by execution of the instruction are ready may be fetched from the issue queue. In some embodiments, in step S150, in response to determining that all the logical registers required by executing the instruction are ready, the instruction to be executed is fetched from the issue queue. In some embodiments, the instruction to be executed and fetched from the issue queue is sent to a corresponding execution unit for execution in step S160.

In some embodiments, in step S160, each time the execution of the instruction is completed, the ready mark rdy of the corresponding virtual register in table 230 is updated. In some embodiments, in step S160, the corresponding physical register (e.g., for storing outdated data or for storing intermediate results from executing a split instruction) according to register renaming table 230 is also released as discussed above. Accordingly, in step S150, instructions are constantly updated to be ready and issued from the issue queue to the corresponding executing unit for execution.

Some embodiments are further discussed with reference to the above instruction str.w r1, (r2, r3). As discussed above, in some embodiments, processor 200 does not support the direct execution of the instruction. Accordingly, in some embodiments, in step S120, the instruction is split into a first split instruction including an add instruction addu r2, r2, r3 and a second split instruction st.w r1, r2. In some embodiments, in step S130, correlation marks are made on the first and second split instructions to indicate that the first split instruction is a producer instruction and the second split instruction is a consumer instruction correlated to the producer instruction. In some embodiments, a correlated virtual register used between the producer instruction and the consumer instruction is logical register r2.

In accordance with register renaming in step S140, before performing register renaming for the first split instruction, physical register p5 configured to store results is allocated to virtual register r2, and physical register p6 configured to store results is allocated to virtual register r3.

In accordance with performing register renaming on the first split add instruction addu r2, r2, r3, since virtual register r2 is a correlated virtual register, the physical register configured to store results and allocated to register r2 is the same as the physical register released after executing the first split add instruction. In the current example, physical register p8 is allocated to register r2 to store intermediate results from executing the first split add instruction, and is further designated to be released after the execution of the first split add instruction is completed. In some embodiments, renaming of the corresponding registers is recorded the register renaming table 230 as shown in FIG. 2.

In accordance with performing register renaming on the second split instruction st.w r1, r2, physical register p8 can be allocated to the virtual register r2 according to the correlation mark (e.g., assigned to the first and second split instructions in step S130), instead of allocating physical register p5 by referring to the register renaming table 230. Accordingly, register renaming table 230 may not be referred to when performing register renaming on the second split instruction. Rather, the correlation mark between the first and second split instructions are used when performing register renaming on the second split instruction.

In some embodiments, after the execution of the first split instruction addu r2, r2, r3 is completed, physical register p8 allocated to virtual register r2 is released. In some embodiments, at the same time, a mapping relation between virtual register r2 and physical register p8 is recorded according to the correlation mark. Meanwhile, since the execution of the first split instruction addu r2, r2, r3 is completed, the ready mark rdy of r2 indicates that content of r2 is ready, and the second split instruction st.w r1, r2 is triggered in step S150 to be issued (e.g., fetched) from the issue queue to an executing unit for execution, e.g., in step S160.

In step S160, the second split instruction used as the consumer instruction is executed normally, and physical register p8 is allocated to the correlated virtual register r2 in accordance with the correlation mark, instead of acquiring content from physical register p5 assigned to r2 based on register renaming table 230. As a result, the final result from executing instruction str.w r1, (r2, r3) is stored in physical register p8, without affecting the value in virtual register r2, or changing the original allocation relationship between virtual register r2 and physical register p5.

By using the above method, instruction splitting based on an implicit correlation is implemented using correlation marks which require minimal hardware resource and without contaminating the virtual register.

FIG. 2 is a schematic diagram of processor 200 for executing instructions, according to some embodiments of the present disclosure. In some embodiments, processor 200 has various components to implement instruction executing method 100 as shown in FIG. 1. In some embodiments, as shown in FIG. 2, processor 200 includes virtual register 210 described above (including, for example, general purpose register (GPR) 212, program counter (PC) 214, and control register (CR) 216), as well as physical register 220 corresponding to virtual register 210. In some embodiments, processor 200 includes a plurality of physical registers 220 P0 to PN. In some embodiments, a number of physical registers 220 depends on the design of the processor 200, and the present disclosure is not limited to the specific number of physical registers 220.

In some embodiments, processor 200 includes an instruction executing device 240 configured to perform instruction executing method 100. In some embodiments, instruction executing device 240 includes a decoding unit 242, an instruction splitting unit 244, a correlation marking unit 246, a register renaming unit 248, and an executing unit 249.

In some embodiments, decoding unit 242 includes circuitry configured to decode instructions, determine an instruction to be split for processing according to the decoding result, and determine an instruction not to be split. In some embodiments, because a specific function of the instruction is known after the instruction is decoded, whether the instruction will be split can also be determined.

In some embodiments, instruction splitting unit 244 includes circuitry configured to split the instruction that is determined by decoding unit 242 to be split. In some embodiments, a method of splitting the instruction has been pre-defined in processor 200, such as how many split instructions the instruction will be split into, whether the split instructions are correlated to each other, and/or which of the correlated instructions are producer instructions and which are correlated consumer instructions. In some embodiments, the instruction is split by instruction splitting unit 244 into two or more split instructions according to the pre-defined method for splitting the instruction in the processor 200.

In some embodiments, register renaming unit 248 includes circuitry configured to perform register renaming on various types of instructions, such as non-split instructions, uncorrelated split instructions, and correlated split instructions. In some embodiments, register renaming includes allocating an idle physical register (e.g., a physical register configured to store results) to virtual register (e.g., a destination register) in an instruction that requires to save the calculation result. For example, the allocated physical register is used for storing data as the calculation result. In some embodiments, a physical register released after completing the instruction execution (e.g., a physical register released after executing the instruction, such as after executing the producer instruction) is further determined. In some embodiments, for the correlated virtual register in the correlated instruction, the physical register configured to store results and allocated by register renaming unit 248 is the same as the physical register released after completing the instruction execution (e.g., execution of the producer instruction).

In some embodiments, correlation marking unit 246 includes circuitry configured to make correlation marks on the correlated instructions split by instruction splitting unit 244 to indicate correlated relationship between producer instructions and consumer instructions in the split instructions and to indicate corresponding correlated virtual registers in the producer instructions and the consumer instructions.

In some embodiments, register renaming unit 248 includes circuitry further configured to designate a corresponding physical register for a virtual register (e.g., a source register) used as a source operand in each instruction, so that content can be acquired from the designated physical register as the value used in the virtual register in the instruction. In some embodiments, when register renaming is performed, if the instruction is not a consumer instruction on which a correlation mark is made by correlation marking unit 246, it is determined that the instruction is an instruction that will not be split, an uncorrelated split instruction, or a producer instruction in the correlated instructions. In some embodiments, the designated physical register is obtained according to a suitable register renaming rule. In some embodiments, for the consumer instruction marked by correlation marking unit 246, register renaming unit 248 can designate a physical register for a correlated virtual register according to the correlation mark. In some embodiments, the designated physical register is the same as the physical register configured to store results and allocated to the correlated virtual register in the producer instruction.

In some embodiments, executing unit 249 includes circuitry configured to execute the split instructions after register renaming unit 248 performs the register renaming on the split instructions.

In some embodiments, processor 200 further includes a register renaming table 230. As shown in FIG. 2, register renaming table 230 lists one or more physical registers allocated to each virtual register reg, including a physical register preg configured to store results and a physical register rreg to be released after executing the instruction. In some embodiments, register renaming unit 248 can record information of the register renaming (e.g., such as register allocation information) in register renaming table 230. In some embodiments, for non-consumer instructions, physical registers designated for various virtual registers can be obtained by referring to register renaming table 230. In some embodiments, for a consumer instruction, a physical register configured to store results designated for the correlated virtual register is acquired from the renaming result of the producer instruction corresponding to the consumer instruction based on the correlation mark, instead of referring to the register renaming table 230.

In some embodiments, in addition to making correlation marks on the split instructions (e.g., establishing an association between the producer instruction and the consumer instruction), the correlation mark is also used to transfer information of the renamed physical registers between the correlated split instructions.

In some embodiments, a mapping relation between the correlated virtual register and the physical register configured to store results can be included in the correlation mark. In some embodiments, register renaming unit 248 can record, for the producer instruction, information of the allocated physical register configured to store results in the correlation mark. In some embodiments, for a consumer instruction, information of the physical register configured to store results and allocated to the correlated virtual register is recorded in the correlation mark and can be acquired by referring to the correlation mark. Accordingly, the physical register configured to store results can be designated as a renamed physical register for the correlated virtual register used in the consumer instruction.

In some embodiments, when the producer instruction and the consumer instruction after splitting are not renamed in the same processor cycle, register renaming unit 248 can further write the information (e.g., a register number) of the correlated virtual register of the producer instruction and the information (e.g., a register number) of the allocated physical register configured to store results into a particular register after register renaming is performed on the producer instruction. Accordingly, in another processor cycle, when register renaming unit 248 performs register renaming on the consumer instruction, the information (e.g., the register number) of the physical register configured to store results can be read from the particular register according to the correlation mark to serve as the physical register designated for the correlated virtual register in the consumer instruction.

In some embodiments, the correlation mark can be implemented in various embodiments. In some embodiments, when a producer instruction and a consumer instruction split from the same instruction are renamed in the same cycle, the correlation mark can be implemented using signals to transmit the correlation mark between the producer instruction and the consumer instruction. In some embodiments, when the producer instruction and the consumer instruction are not renamed in the same cycle, the correlation mark can be implemented as a table entry. In some embodiments, the correlation mark is recorded in a certain table as a table entry. In some embodiments, the producer instruction can record a mapping relation between the virtual register and the physical register configured to store results according to the table entry. Accordingly, the consumer instruction can acquire the mapping relation according to the table entry, and then obtain content used in the virtual register. The present disclosure is not limited to a specific implementation embodiment of the correlation mark. All suitable embodiments for establishing an association between the producer instruction and the consumer instruction and for transmitting the mapping relation between the virtual register and the physical register configured to store results are included in the protective scope of the present disclosure.

In some embodiments, a ready mark rdy is further recorded in register renaming table 230 for each virtual register. In some embodiments, the ready mark rdy indicates whether the value in the corresponding virtual register is ready. After register renaming unit 248 performs register renaming, the executing unit saves the instruction in an issue queue. In some embodiments, the instruction can be fetched from the issue queue and executed when the ready mark of the virtual register (such as the virtual register configured to store a source operand) associated with the instruction indicates a ready state according to register renaming table 230.

It should be noted that the present disclosure is not limited to the above described embodiment where register renaming table 230 is described as separate from (e.g., outside) instruction executing device 240. In some embodiments, register renaming table 230 can be included in instruction executing device 240 without departing from the protective scope of the present disclosure.

In some embodiments, according to the solutions of the instruction executing device and processor of the present disclosure, an implicit correlation is established between correlated split instructions using correlation marks implemented via signals or table entries. In some embodiments during register renaming, subsequent split instructions and non-split instructions are processed in the same way when the allocated physical registers of the split instructions with an implicit correlation are the same as the released physical registers. In some embodiments, after completing the execution of the split instructions, only their allocated physical registers are released without changing the mapping relationship of other virtual registers. In these embodiments, while a correlation is established between two split instructions, the intermediate result of the split instructions will not change the value of any virtual register, so that no virtual register will be contaminated and the instruction will be split with a reduced hardware resource overhead.

The embodiments may further be described using the following clauses:

1. A method for executing instructions, comprising:

decoding instructions to identify an instruction to be split;

splitting the identified instruction into two or more split instructions, the split instructions comprising correlated instructions having a correlation, and the correlated instructions having a corresponding virtual register;

performing register renaming on the split instructions, wherein for the correlated instructions, a first physical register configured to store results and allocated to the corresponding virtual register is the same as a second physical register designated to be released after executing at least one of the split instructions; and

executing the split instructions after the register renaming.

2. The method of clause 1, further comprising:

making correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction;

wherein performing register renaming further comprises:
allocating the first physical register to the destination register in the split instructions and designating the second physical register to be released after executing the producer instruction; and
designating a third physical register from which a value is taken for the source register in the consumer instruction;

wherein for the corresponding virtual register in the producer instruction, the allocated first physical register is the same as the designated second physical register; and

wherein the designated third physical register for the corresponding virtual register in the consumer instruction is the same as the first physical register and allocated to the corresponding virtual register in the producer instruction.

3. The method of clause 2, wherein performing register renaming further comprises:

recording, in a register renaming table, information of the first physical register allocated to the destination register in the split instructions and information of the designated second physical register to be released after executing the producer instruction.

4. The method of clause 3, wherein the information of the first physical register, the information of the second physical register, and a ready mark of the corresponding virtual register are recorded in the register renaming table for the virtual register, wherein the ready mark indicates whether the value in the virtual register is ready; and

wherein executing the renamed split instructions comprises:
saving the consumer instruction in an issue queue; and
fetching the consumer instruction from the issue queue and executing the consumer instruction when the ready mark of the virtual register associated with the consumer instruction in the register renaming table indicates a ready state.

5. The method of clause 2, wherein the correlation mark further comprises a mapping relation between the corresponding virtual register and the first physical register, and performing register renaming comprises:

recording, for the producer instruction, the allocated first physical register in the correlation mark; and

acquiring, for the consumer instruction, the allocated first physical register according to the correlation mark as the third physical register designated for the corresponding virtual register and from which a value is taken.

6. The method of clause 5, wherein the register renaming of the producer instruction and the register renaming of the consumer instruction are not performed in the same processor cycle, and performing register renaming comprises:

writing, for the producer instruction, a number of the corresponding virtual register and a number of the allocated first physical register into a particular register; and

reading, for the consumer instruction, the number of the allocated first physical register from the particular register to serve as the number of the third physical register designated for the corresponding virtual register and from which a value is taken.

7. The method of clause 2, wherein the correlation mark is implemented using a signal or a table entry record.

8. An instruction executing device in a processor, comprising:

a decoding unit including circuitry configured to decode instructions to identify an instruction to be split;

an instruction splitting unit including circuitry configured to split the identified instruction into two or more split instructions, the split instructions comprising correlated instructions having a correlation, and the correlated instructions having a corresponding virtual register;

a register renaming unit including circuitry configured to perform register renaming on the split instructions, wherein for the correlated instructions, a first physical register configured to store results and allocated to the corresponding virtual register is the same as a second physical register designated to be released after executing at least one of the split instructions; and

an executing unit including circuitry configured to execute the split instructions after the register renaming.

9. The instruction executing device of clause 8, further comprising:

a correlation marking unit including circuitry configured to make correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction,

wherein the register renaming unit is configured to:
allocate the first physical register to the destination register in the split instructions and designate the second physical register to be released after executing the producer instruction; and
designate a third physical register from which a value is taken for the source register in the consumer instruction;

wherein for the corresponding virtual register in the producer instruction, the allocated first physical register is the same as the designated second physical register, and

wherein the designated third physical register for the corresponding virtual register in the consumer instruction is the same as the first physical register and allocated to the corresponding virtual register in the producer instruction.

10. The instruction executing device of clause 9, further comprising:

a register renaming table configured to record information of the first physical register and allocated to the destination register in the split instructions when the register is renamed and information of the second physical register designated to be released after executing the producer instruction.

11. The instruction executing device of clause 10, wherein the register renaming table further comprises a ready mark of each virtual register, the ready mark indicating whether the value in the corresponding virtual register is ready; and

wherein the executing unit is configured to save the consumer instruction in an issue queue; and fetch the consumer instruction from the issue queue and execute the consumer instruction when the ready mark of the virtual register associated with the consumer instruction in the register renaming table indicates a ready state.

12. The instruction executing device of clause 9, wherein the correlation mark further comprises a mapping relation between the corresponding virtual register and the first physical register; and

the register renaming unit is further adapted to record, for the producer instruction, the allocated first physical register in the correlation mark; and acquire, for the consumer instruction, the allocated first physical register according to the correlation mark as the third physical register designated for the corresponding virtual register and from which a value is taken.

13. The instruction executing device of clause 12, wherein the register renaming of the producer instruction and the register renaming of the consumer instruction are not performed in the same processor cycle, and the register renaming unit is configured to write, for the producer instruction, a number of the corresponding virtual register and a number of the allocated physical register configured to save results into a particular register; and read, for the consumer instruction, the number of the allocated first physical register configured to save results from the particular register to serve as the number of the third physical register designated for the corresponding virtual register and from which a value is taken.

14. The instruction executing device of clause 9, wherein the correlation mark is implemented using a signal or a table entry record.

15. A processor comprising:

an instruction executing device comprising:
a decoding unit including circuitry configured to decode instructions to identify an instruction to be split;
an instruction splitting unit including circuitry configured to split the identified instruction into two or more split instructions, the split instructions comprising correlated instructions having a correlation, and the correlated instructions having a corresponding virtual register;
a register renaming unit including circuitry configured to perform register renaming on the split instructions, wherein for the correlated instructions, a first physical register configured to store results and allocated to the corresponding virtual register is the same as a second physical register designated to be released after executing at least one of the split instructions; and
an executing unit including circuitry configured to execute the split instructions after the register renaming.

16. The processor of clause 15, wherein the instruction executing device further comprises:

a correlation marking unit including circuitry configured to make correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction,

wherein the register renaming unit is configured to:
allocate the first physical register to the destination register in the split instructions and designate the second physical register to be released after executing the producer instruction; and
designate a third physical register from which a value is taken for the source register in the consumer instruction;

wherein for the corresponding virtual register in the producer instruction, the allocated first physical register is the same as the designated second physical register, and

wherein the designated third physical register for the corresponding virtual register in the consumer instruction is the same as the first physical register and allocated to the corresponding virtual register in the producer instruction.

17. The processor of clause 15, further comprising:
a register renaming table configured to record information of the first physical register and allocated to the destination register in the split instructions when the register is renamed and information of the second physical register designated to be released after executing the producer instruction.

18. The processor of clause 17, wherein the register renaming table further comprises a ready mark of each virtual register, the ready mark indicating whether the value in the corresponding virtual register is ready; and

wherein the executing unit is configured to save the consumer instruction in an issue queue; and fetch the consumer instruction from the issue queue and execute the consumer instruction when the ready mark of the virtual register associated with the consumer instruction in the register renaming table indicates a ready state.

19. The processor of clause 16, wherein the correlation mark further comprises a mapping relation between the corresponding virtual register and the first physical register; and

the register renaming unit is further adapted to record, for the producer instruction, the allocated first physical register in the correlation mark; and acquire, for the consumer instruction, the allocated first physical register according to the correlation mark as the third physical register designated for the corresponding virtual register and from which a value is taken.

20. The processor of clause 19, wherein the register renaming of the producer instruction and the register renaming of the consumer instruction are not performed in the same processor cycle, and the register renaming unit is configured to write, for the producer instruction, a number of the corresponding virtual register and a number of the allocated physical register configured to save results into a particular register; and read, for the consumer instruction, the number of the allocated first physical register configured to save results from the particular register to serve as the number of the third physical register designated for the corresponding virtual register and from which a value is taken.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It should be understood that in order to simplify this disclosure and to assist in understanding one or more of the various aspects of the present disclosure, in the above description about the exemplary embodiments of the present disclosure, various features of the present disclosure are sometimes grouped together into individual embodiments, diagrams, or their descriptions. However, the disclosed method shall not be interpreted as that the present disclosure claimed for protection requires it to have more features than those clearly recited in each claim. In some embodiments, the disclosure aspects, as reflected in the following claims, may include less than all the features of the individual embodiments disclosed previously. Therefore, the claims that follow specific implementations are explicitly incorporated into the specific implementation, where each claim itself is regarded as a separate embodiment of the present disclosure.

It should be appreciated by those skilled in the art that modules or units or components of the device in the example disclosed herein may be placed in the device as described in the embodiment, or alternatively may be located in one or more devices that are different from the device in the example. The modules in the above example can be combined into a single module or can be further divided into a plurality of submodules.

It could be appreciated by those skilled in the art that the modules in the device in the embodiment can be adaptively changed and provided in one or more devices that are different from the device in the embodiment. The modules or units or components in the embodiment can be combined into one module or unit or component, and in addition, they can be divided into a plurality of submodules or subunits or subcomponents. Except that at least some of such features and/or the processes or units are mutually exclusive, any combination may be used to combine all the features disclosed in this specification (including the appended claims, abstract, and accompanying drawings) and all the processes or units of any method or device so disclosed. Unless otherwise clearly stated, each feature disclosed in this specification (including the appended claims, abstract, and accompanying drawings) can be replaced with an alternative feature that provides the same, equivalent, or similar purpose.

In addition, it can be appreciated by those skilled in the art that although some embodiments described here include some features rather than other features in other embodiments, the combination of features in different embodiments means that the combination is encompassed in the scope of the present disclosure and forms a different embodiment. For example, any of the embodiments claimed for protection can be used in any combination in the following claims.

In addition, some of the embodiments are described here as a method or combinations of method elements that can be implemented by a processor of a computer system or by other apparatuses performing the functions. Therefore, a processor having necessary instructions for implementing the method or method elements forms an apparatus configured to implement the method or method elements. In addition, the element of the apparatus embodiment described here is an example of an apparatus configured to perform a function performed by an element for achieving the objective of the present disclosure.

As used here, unless otherwise stated, ordinary objects described with the ordinal numbers “first,” “second,” “third,” and so on merely indicate different examples involving similar objects, and are not intended to imply that the objects so described must have a given order in time, space, ranking, or any other embodiments.

Although the present disclosure is described according to a limited number of embodiments, those skilled in the art understand, by virtue of the above description, that other embodiments may be conceived within the scope of the present disclosure as described. In addition, it should be noted that the language used in this specification is selected primarily for readability and teaching purposes, not to explain or limit the subject matter of the present disclosure. Therefore, many modifications and changes made without departing from the scope and spirit of the appended claims are obvious to those of ordinary skill in the art. For the scope of the present disclosure, this disclosure of the present disclosure is illustrative rather than restrictive.

What is claimed is:

1. A method for executing instructions, comprising:
decoding instructions to identify an instruction to be split;
splitting the identified instruction into two or more split instructions, the split instructions comprising correlated instructions having a correlation, and the correlated instructions having a corresponding virtual register;
performing register renaming on the split instructions, wherein for the correlated instructions, a first physical register configured to store results and allocated to the corresponding virtual register is the same as a second physical register designated to be released after executing at least one of the split instructions; and
executing the split instructions after the register renaming.

2. The method of claim 1, further comprising:
making correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction;
wherein performing register renaming further comprises:
allocating the first physical register to the destination register in the split instructions and designating the second physical register to be released after executing the producer instruction; and
designating a third physical register from which a value is taken for the source register in the consumer instruction;
wherein for the corresponding virtual register in the producer instruction, the allocated first physical register is the same as the designated second physical register; and
wherein the designated third physical register for the corresponding virtual register in the consumer instruction is the same as the first physical register and allocated to the corresponding virtual register in the producer instruction.

3. The method of claim 2, wherein performing register renaming further comprises:
recording, in a register renaming table, information of the first physical register allocated to the destination register in the split instructions and information of the designated second physical register to be released after executing the producer instruction.

4. The method of claim 3, wherein the information of the first physical register, the information of the second physical register, and a ready mark of the corresponding virtual register are recorded in the register renaming table for the virtual register, wherein the ready mark indicates whether the value in the virtual register is ready; and
wherein executing the renamed split instructions comprises:
saving the consumer instruction in an issue queue; and
fetching the consumer instruction from the issue queue and executing the consumer instruction when the ready mark of the virtual register associated with the consumer instruction in the register renaming table indicates a ready state.

5. The method of claim 2, wherein the correlation mark further comprises a mapping relation between the corresponding virtual register and the first physical register, and performing register renaming comprises:
recording, for the producer instruction, the allocated first physical register in the correlation mark; and
acquiring, for the consumer instruction, the allocated first physical register according to the correlation mark as the third physical register designated for the corresponding virtual register and from which a value is taken.

6. The method of claim 5, wherein the register renaming of the producer instruction and the register renaming of the consumer instruction are not performed in the same processor cycle, and performing register renaming comprises:
writing, for the producer instruction, a number of the corresponding virtual register and a number of the allocated first physical register into a particular register; and
reading, for the consumer instruction, the number of the allocated first physical register from the particular register to serve as the number of the third physical register designated for the corresponding virtual register and from which a value is taken.

7. The method of claim 2, wherein the correlation mark is implemented using a signal or a table entry record.

8. An instruction executing device in a processor, comprising:
a decoding unit including circuitry configured to decode instructions to identify an instruction to be split;
an instruction splitting unit including circuitry configured to split the identified instruction into two or more split instructions, the split instructions comprising correlated instructions having a correlation, and the correlated instructions having a corresponding virtual register;
a register renaming unit including circuitry configured to perform register renaming on the split instructions, wherein for the correlated instructions, a first physical register configured to store results and allocated to the corresponding virtual register is the same as a second physical register designated to be released after executing at least one of the split instructions; and
an executing unit including circuitry configured to execute the split instructions after the register renaming.

9. The instruction executing device of claim 8, further comprising:
a correlation marking unit including circuitry configured to make correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction,
wherein the register renaming unit is configured to:
allocate the first physical register to the destination register in the split instructions and designate the second physical register to be released after executing the producer instruction; and
designate a third physical register from which a value is taken for the source register in the consumer instruction;
wherein for the corresponding virtual register in the producer instruction, the allocated first physical register is the same as the designated second physical register, and
wherein the designated third physical register for the corresponding virtual register in the consumer instruction is the same as the first physical register and allocated to the corresponding virtual register in the producer instruction.

10. The instruction executing device of claim 9, further comprising:
a register renaming table configured to record information of the first physical register and allocated to the destination register in the split instructions when the register is renamed and information of the second physical register designated to be released after executing the producer instruction.

11. The instruction executing device of claim 10, wherein the register renaming table further comprises a ready mark of each virtual register, the ready mark indicating whether the value in the corresponding virtual register is ready; and
wherein the executing unit is configured to save the consumer instruction in an issue queue; and fetch the consumer instruction from the issue queue and execute the consumer instruction when the ready mark of the virtual register associated with the consumer instruction in the register renaming table indicates a ready state.

12. The instruction executing device of claim 9, wherein the correlation mark further comprises a mapping relation between the corresponding virtual register and the first physical register; and
the register renaming unit is further adapted to record, for the producer instruction, the allocated first physical register in the correlation mark; and acquire, for the consumer instruction, the allocated first physical register according to the correlation mark as the third physical register designated for the corresponding virtual register and from which a value is taken.

13. The instruction executing device of claim 12, wherein the register renaming of the producer instruction and the register renaming of the consumer instruction are not performed in the same processor cycle, and the register renaming unit is configured to write, for the producer instruction, a number of the corresponding virtual register and a number of the allocated physical register configured to save results into a particular register; and read, for the consumer instruction, the number of the allocated first physical register configured to save results from the particular register to serve as the number of the third physical register designated for the corresponding virtual register and from which a value is taken.

14. The instruction executing device of claim 9, wherein the correlation mark is implemented using a signal or a table entry record.

15. A processor comprising:
an instruction executing device comprising:
a decoding unit including circuitry configured to decode instructions to identify an instruction to be split;
an instruction splitting unit including circuitry configured to split the identified instruction into two or more split instructions, the split instructions comprising correlated instructions having a correlation, and the correlated instructions having a corresponding virtual register;
a register renaming unit including circuitry configured to perform register renaming on the split instructions, wherein for the correlated instructions, a first physical register configured to store results and allocated to the corresponding virtual register is the same as a second physical register designated to be released after executing at least one of the split instructions; and
an executing unit including circuitry configured to execute the split instructions after the register renaming.

16. The processor of claim 15, wherein the instruction executing device further comprises:
a correlation marking unit including circuitry configured to make correlation marks on the correlated instructions to indicate a producer instruction and a consumer instruction in the correlated instructions, wherein the corresponding virtual register is used as a destination register in the producer instruction, and the corresponding virtual register is used as a source register in the consumer instruction,
wherein the register renaming unit is configured to:
allocate the first physical register to the destination register in the split instructions and designate the second physical register to be released after executing the producer instruction; and
designate a third physical register from which a value is taken for the source register in the consumer instruction;
wherein for the corresponding virtual register in the producer instruction, the allocated first physical register is the same as the designated second physical register, and
wherein the designated third physical register for the corresponding virtual register in the consumer instruction is the same as the first physical register and allocated to the corresponding virtual register in the producer instruction.

17. The processor of claim 15, further comprising:
a register renaming table configured to record information of the first physical register and allocated to the destination register in the split instructions when the register is renamed and information of the second physical register designated to be released after executing the producer instruction.

18. The processor of claim 17, wherein the register renaming table further comprises a ready mark of each virtual register, the ready mark indicating whether the value in the corresponding virtual register is ready; and
wherein the executing unit is configured to save the consumer instruction in an issue queue; and fetch the consumer instruction from the issue queue and execute the consumer instruction when the ready mark of the virtual register associated with the consumer instruction in the register renaming table indicates a ready state.

19. The processor of claim 16, wherein the correlation mark further comprises a mapping relation between the corresponding virtual register and the first physical register; and
the register renaming unit is further adapted to record, for the producer instruction, the allocated first physical register in the correlation mark; and acquire, for the consumer instruction, the allocated first physical register according to the correlation mark as the third physical register designated for the corresponding virtual register and from which a value is taken.

20. The processor of claim 19, wherein the register renaming of the producer instruction and the register renaming of the consumer instruction are not performed in the same processor cycle, and the register renaming unit is configured to write, for the producer instruction, a number of the corresponding virtual register and a number of the allocated physical register configured to save results into a particular register; and read, for the consumer instruction, the number of the allocated first physical register configured to save results from the particular register to serve as the number of the third physical register designated for the corresponding virtual register and from which a value is taken.
